(19) United States
(12) Patent Application Publication
(10) Pub. No.: US 2010/0104853 A1
(43) Pub. Date: Apr. 29, 2010

(54) FOAM TAPE

(75) Inventors: Seung Min YOO, Daejeon (KR); Jang Soon KIM, Daejeon (KR); Ik Hwan CHO, Daejeon (KR)

Correspondence Address: CANTOR COLBURN, LLP, 20 Church Street, 22nd Floor, Hartford, CT, 06103, US

(73) Assignee: LG HAUSYS, LTD., Seoul (KR)

(21) Appl. No.: 12/579,576

(22) Filed: Oct. 15, 2009

(30) Foreign Application Priority Data
Oct. 15, 2008 (KR) 10-2008-0101286

(51) Int. Cl. B32B 7/12

(52) U.S. Cl. 428/317.3; 427/536

(57) ABSTRACT

Provided is a foam tape including a foam and an adhesive layer. Since interfacial adhesion strength between the foam and the adhesive layer is improved through corona treatment, the foam tape can support heavy articles, even at high temperature, for a long time. Also, a manufacturing process for a foam tape is provided, by which the foam tape can be simply prepared, and the manufacturing cost can be reduced.

### CROSS-REFERENCE TO RELATED APPLICATION

This application claims priority from, and the benefit of, Korean Patent Application No. 2008-0101286, filed on Oct. 15, 2008, the disclosure of which is incorporated herein by reference in its entirety.

### BACKGROUND

1. Field of the Invention

The present invention relates to a foam tape in which interfacial adhesion strength between a foam and an adhesive layer is improved through corona treatment.

2. Discussion of Related Art

Foam tapes are widely used for adhering various decorative interior materials to kitchen furniture, such as sinks, and household goods, or interior/exterior decorative materials to vehicles. In particular, foam tapes are often adhered to films or painted surfaces coated on glass, in order to decorate an external shape.

In general, foam tapes are manufactured by the following process. First, a foam is prepared, and, depending on the intended use, various kinds of adhesive layers are prepared. Then, the foam and the adhesive layers are laminated together to manufacture a foam tape.

Korean laid open Patent No. 2000-0018221 discloses a method for manufacturing a foam tape for bumpers and a foam tape composition. In the method, the foam tape for bumpers is prepared by uniformly mixing a composition including urethaneacrylate, epoxyacrylate, 2-hydroxyethyl methacrylate, 1,6-hexanediol diacrylate, glass macroballoons, pigment, and a photoinitiator; coating the composition onto a guide film; and then, while passing the guide film onto which the composition is coated through an ultraviolet curing machine so as to form a foam, laminating an adhesive layer on one surface of the foam.

Korean laid open Patent No. 2008-0037876 discloses a foam tape for interior decoration and a method thereof. In the method, the foam tape for interior decoration is prepared by mixing a composition including acryl monomers, a radical initiator, a crosslinking agent and porous fillers; coating the composition on a baking film; and passing the baking film coated with the composition through a UV curing machine to form and polymerize the foam simultaneously. The method is characterized in that the step of forming the foam tape is performed by consecutively passing the baking film through a 10 to 60 W UV transilluminator and a 1000 to 3000 W UV transilluminator.

However, the foam tapes disclosed in the prior arts have the disadvantages described below.

Generally, foam tapes are used for supporting heavy articles, and therefore strong adhesion property is required.

However, when the adhesion strength between the foam and the adhesion layer is lower than the weight of the heavy articles which are supported by the foam tape, interfacial peel-off between the foam and the adhesive layer occurs. Further, even when the adhesion strength between the foam and the adhesion layer is sufficient at room temperature, the adhesion strength may decrease at a high temperature such that interfacial peel-off can occur easily.

Moreover, when a foam tape is attached to a plasticized polyvinylchloride substrate, a plasticizer included in the substrate may migrate to the foam tape, such that the function of the foam tape is degraded. That is, even if the foam tape has withstood the weight of articles at first, the property of the foam tape may be degraded over time by the plasticizer migrating from the substrate.

To solve these problems, a primer layer may be introduced between the foam and the adhesive layer. However, the use of a primer increases the cost, and decreases productivity since additional processes should be performed.

### SUMMARY OF THE INVENTION

The object of the present invention is to provide a foam tape and a method for preparing the same.

One aspect of the present invention provides a foam tape including a corona-treated foam and an adhesive layer.

Another aspect of the present invention provides a method for preparing a foam tape, including subjecting a foam to corona treatment; and forming an adhesive layer on the foam.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a cross-sectional view of one exemplary embodiment of the foam tape according to the present invention.

### DETAILED DESCRIPTION OF EXEMPLARY EMBODIMENTS

The present invention relates to a foam tape, including a corona-treated foam; and an adhesive layer that is formed on one or both sides of the foam.

Hereinafter, the present invention will be described in detail.

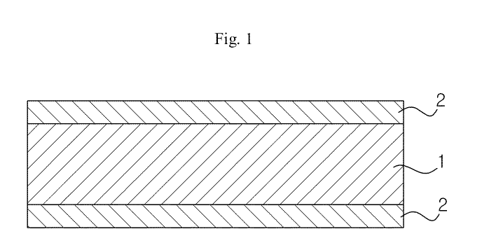

FIG. 1 is a cross-sectional view of one exemplary embodiment of the foam tape. As shown in FIG. 1, the foam tape may include a foam layer and adhesive layers formed on both sides of the foam layer. Alternatively, the foam tape may include a foam layer and an adhesive layer formed on one side of the foam layer.

In the present invention, the foam layer is a corona-treated foam. The term “corona-treated foam” or “corona-treated foam layer” as used herein refers to a foam or foam layer to which corona treatment has been performed. Corona treatment is a surface treatment process that increases the surface energy of the treated material by irradiating a corona discharge onto the material. In the present invention, the method for performing the corona treatment is not particularly limited, and it may be performed using conventional corona treating equipment including a high-frequency power generator, a high-voltage transformer, stationary electrodes, and the like. Also, the conditions under which the treatment is performed are not particularly limited, and a person skilled in the art can easily determine appropriate conditions considering the kind of foam to be treated, and the like. In one embodiment, the corona treatment may be performed under conditions in which a current is adjusted to between 2 A to 10 A, and the processing rate is adjusted to between 1 M/min to 10 M/min, preferably 1 M/min to 5 M/min, more preferably 1 M/min to 2 M/min. By controlling the conditions of the corona treatment, the interfacial adhesion strength between the foam layer and the adhesive layer may be optimized.

The kinds of foam usable herein are not particularly limited, and any conventional foam used in the field may be applied. For example, foams prepared by polymerizing a mixture comprising at least one selected from the group consisting of an acryl compound, a urethane compound and an olefin compound such as ethylene may be used. In another embodiment, the foams disclosed in Korean laid open patent No. 2000-0018221 or 2008-0037876 may be used.

The kinds of adhesive layer usable herein are not particularly limited, and any materials widely used in the field may be used. Examples of the adhesive may include an ultraviolet curable adhesive and a thermal curable adhesive.

In one embodiment, the adhesive layer may be a cured product of an adhesive composition including an acryl copolymer. In one embodiment, the acryl copolymer may be a polymer of a monomer mixture including a (meth)acrylic acid ester monomer and (meth)acrylic acid.

The kinds of (meth)acrylic acid monomer usable herein are not particularly limited. For example, an alkyl (meth)acrylate having an alkyl group with 1 to 14 carbon atoms may be used. An example of such a monomer may include, but is not limited to, one or more selected from the group consisting of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate and tetradecyl (meth)acrylate.

In one embodiment, the weight ratio of the (meth)acrylic acid ester monomer and the (meth)acrylic acid may be 8:1 to 9.5:1. That is, the monomer mixture may include the (meth)acrylic acid ester monomer in an amount of 800 to 950 parts by weight, relative to 100 parts by weight of the (meth)acrylic acid. By controlling the contents of the monomers in the mixture, the interfacial adhesion strength between the foam layer and the adhesive layer may be optimized.

The method for preparing the copolymer is not particularly restricted. For example, it can be prepared through general methods such as solution polymerization, photo-polymerization, bulk polymerization, suspension polymerization, or emulsion polymerization.

The adhesive composition may further comprise a crosslinking agent, which can react with the copolymer and give a crosslinking structure to the adhesive.

The specific cross-linking agent which may be used herein is not particularly restricted, and may include, for example, an isocyanate compound, an epoxy compound, an aziridine compound and a metal chelate compound.

Examples of the isocyanate compound include tolylene diisocyanate, xylene diisocyanate, diphenylmethane diisocyanate, hexamethylene diisocyanate, isophorone diisocyanate, tetramethylxylene diisocyanate, naphthalene diisocyanate and a reaction product of any one of the foregoing with a polyol such as trimethylol propane; examples of the epoxy compound include ethyleneglycol diglycidylether, triglycidylether, trimethylolpropane triglycidylether, N,N,N′,N′-tetraglycidyl ethylenediamine and glycerin diglycidylether; examples of the aziridine compound include N,N′-toluene-2,4-bis(1-aziridinecarboxamide), N,N′-diphenylmethane-4,4′-bis(1-aziridinecarboxamide), triethylene melamine, bisisophthaloyl-1-(2-methylaziridine) and tri-1-aziridinylphosphine oxide. Also, examples of the metal chelate compound include compounds in which a multivalent metal such as aluminum, iron, zinc, tin, titanium, antimony, magnesium and/or vanadium is chelated to acetyl acetone or ethyl acetoacetate. In the present invention, one or two or more of the forgoing may be used alone or in a mixture thereof.

The cross-linking agent may be contained in an amount of 0.01 to 10 parts by weight, and preferably 0.01 to 5 parts by weight, relative to 100 parts by weight of the copolymer. If said content is less than 0.01 parts by weight, the cohesion of the adhesive is lowered. If it is in excess of 10 parts by weight, the endurance is lowered.

In one embodiment, the adhesive composition may further comprise one or more additives selected from the group consisting of an epoxy resin, a hardener, a UV stabilizer, an antioxidant, a colorant, a reinforcing agent, a filling agent, a defoaming agent, a surfactant and a plasticizer, in a range not affecting the effects of the present invention.

The present invention also relates to a method for preparing a foam tape, including: preparing a corona-treated foam by subjecting a foam to corona treatment; and forming an adhesive layer on the corona-treated foam layer.

In the present invention, methods for preparing a corona-treated foam layer are not particularly limited. The corona-treated foam layer may be prepared by subjecting a foam prepared by conventional methods to corona treatment using conventional corona treatment equipment. Corona treatment is a method for increasing the wettability of a target through high frequency electrical discharge. Corona treatment may be performed by radiating a corona, generated by applying a high-frequency high voltage between two electrodes, to a target. The method for performing the corona-discharge treatment is not specifically limited in the present invention, and can be any method generally used in this field without restriction. In one embodiment, the current for the corona treatment may be controlled to be in a range from 2 A to 10 A, and the processing rate may be controlled within a range from 1 M/min to 2 M/min.

In one embodiment, the corona-treated foam layer may be further subjected to plasma treatment. By subjecting the corona-treated foam to plasma treatment, the interfacial adhesion strength between the foam layer and the adhesive layer may be further improved. The specific methods or conditions for the plasma treatment are not particularly limited, and a person skilled in the art can easily determine them by considering the kind of foam to be treated, and the like.

Also, methods for forming an adhesive layer on the corona-treated foam layer are not particularly limited. In one embodiment, the step for forming an adhesive layer may include forming an adhesive layer; and laminating the adhesive layer on the corona-treated foam layer.

In the above, the method for forming an adhesive layer is not particularly restricted, and may be, for example, a method of coating and hardening the adhesive composition on said foam layer with a bar coater and the like, or a method of coating and drying the adhesive composition on the surface of a releasable substrate and then transferring the formed adhesive layer to the foam layer.

Hereinafter, exemplary embodiments will be described. The following exemplary embodiments are described to facilitate understanding of the technical idea of the present invention, but do not limit the scope of the present invention.

### Example 1

### Preparation of a Foam Layer

A mixture comprising 89 parts by weight of 2-ethylhexylacrylate, and 11 parts by weight of acrylic acid was thermally polymerized in a 1 L glass reactor to obtain a syrup having a viscosity of 3,500 cP. Then, 0.5 parts by weight of a photo initiator (α,α-methoxy-α-hydroxyacetophenone, irgacure-651) and 0.35 parts by weight of 1,6-hexanediol diacrylate (HDDA) were added to 100 parts by weight of the syrup to obtain a mixture, and then the mixture was sufficiently stirred. Then, 5 parts by weight of glass bubbles and 2 parts by weight of silica were added to the mixture, and the mixture was stirred until it was sufficiently homogenous. The mixture was then degassed using a vacuum pump. Then, a microbar was used to prepare a foam layer having a thickness of 0.4 mm.

### Preparation of an Adhesive Layer

A monomer mixture comprising 90 parts by weight of 2-ethylhexylacrylate and 10 parts by weight of acrylic acid was solution polymerized in a 1 L glass reactor to prepare a syrup having a weight average molecular weight of about 1,500,000 and a solid content of 21%. Then, 0.01 parts by weight of aziridine crosslinking agent was added to 100 parts by weight of the prepared syrup to prepare a mixture, and the mixture was sufficiently stirred. Then, the mixture was dried in an oven at 100° C. for 3 minutes to prepare an adhesive layer having a thickness of 50 μm. Then, the prepared adhesive layer was subjected to an aging process in an oven at 50° C. for 48 hours.

Preparation of a Foam Tape

Corona treatment was performed on the prepared foam layer by using conventional corona treatment equipment. The current was 6 A and the processing speed was 2 M/min. Then, the prepared adhesive layer was laminated onto the corona-treated foam layer to prepare a foam tape. Then, the prepared foam tape was put into an oven at 50° C. and subjected to an aging process for 24 hours.

### Comparative Example 1

A foam tape was prepared by using same method as described in Example 1, except that the corona treatment was not performed.

Experiment Results

A test to examine the adhesion strength between the foam layer and the adhesive layer at high temperature was performed on the foam tape of Example 1 and Comparative Example 1, and the results are shown in Table 1.

As shown in Table 1, it can be seen that interfacial peel-off hardly occurs in Example 1 in comparison with Comparative Example 1.

TABLE 1

| | Example 1 | Comparative Example 1 |
|---|---|---|
| Maintenance time | 107 minutes | 15 minutes |
| Interfacial peel-off | Did not occur | Occurred |

Experimental Method

The foam tapes of Example 1 and Comparative Example 1 were cut to a size of 0.5 inch×0.5 inch, and then stacked between SUS and SUS to prepare laminates. Then, a weight of 1 kg was placed on bonded regions of the laminates for 15 minutes, and then removed. After that, the laminates were left at room temperature for 24 hours. Then, the laminates were placed in an oven at 80° C. for 10 minutes. After that, the laminates had 1 kg of weight suspended from them, and the time (maintenance time) until peel-off between the foam tape and SUS occurred was examined. Also, whether interfacial peel-off between the foam layer and the adhesive layer occurred or not was examined. The maintenance time was tested 5 times, and the average value thereof was recorded.

According to the present invention, since the interfacial adhesion strength between a foam layer and an adhesive layer of a foam tape is improved, the foam tape can support heavy articles, even at high temperature, for a long time.

Further, in the present invention, the foam tape can be prepared through a simple manufacturing process, and the manufacturing cost can be reduced.

What is claimed is:

1. A foam tape comprising:
a corona-treated foam; and
an adhesive layer that is formed on one or both sides of the foam.

2. The foam tape according to claim 1, wherein the corona-treated foam layer is prepared by performing corona treatment on a foam layer with an electrical current of 2 A to 10 A, and a processing speed of 1 M/min to 10 M/min.

3. The foam tape according to claim 1, wherein the corona-treated foam layer is prepared by successively performing corona treatment and plasma treatment on a foam layer.

4. The foam tape according to claim 2, wherein the foam layer is prepared by polymerizing a mixture comprising at least one selected from the group consisting of an acryl compound, a urethane compound and an olefin compound.

5. The foam tape according to claim 1, wherein the adhesive layer comprises a cured product of an adhesive composition comprising an acrylic copolymer.

6. The foam tape according to claim 5, wherein the acrylic copolymer is a polymer of a monomer mixture comprising a (meth)acrylic acid ester monomer and (meth)acrylic acid.

7. The foam tape according to claim 6, wherein the monomer mixture comprises a (meth)acrylic acid ester monomer in an amount of 800 to 950 parts by weight, relative to 100 parts by weight of the (meth)acrylic acid.

8. A method for manufacturing a foam tape, comprising:
preparing a corona-treated foam by subjecting a foam to corona treatment; and
forming an adhesive layer on one or both sides of the corona-treated foam.

9. The method according to claim 8, further subjecting the corona-treated foam to plasma treatment.
